(19) United States
(12) Patent Application Publication
(10) Pub. No.: US 2022/0222831 A1
(43) Pub. Date: Jul. 14, 2022

(54) METHOD FOR PROCESSING IMAGES AND ELECTRONIC DEVICE THEREFOR

(71) Applicant: BEIJING DAJIA INTERNET INFORMATION TECHNOLOGY CO., LTD., Beijing (CN)

(72) Inventors: Xiaozheng HUANG, Beijing (CN); Yunfei ZHENG, Beijing (CN); Xing WEN, Beijing (CN)

(21) Appl. No.: 17/706,457

(22) Filed: Mar. 28, 2022

Related U.S. Application Data
(63) Continuation of application No. PCT/CN2020/110771, filed on Aug. 24, 2020.

(30) Foreign Application Priority Data
Sep. 29, 2019 (CN) 201910936022.1

(51) Int. Cl. G06T 7/246; G06T 7/11; G06T 7/174

(52) U.S. Cl. CPC G06T 7/246; G06T 7/174; G06T 7/11

(57) ABSTRACT

A method for processing images includes: acquiring at least one first video image in a video to be processed; determining a first target region of the at least one first video image by performing region recognition on the at least one first video image; and determining, based on the first target region of the at least one first video image, a second target region of at least one second video image in the video to be processed other than the first video images, wherein the second video image is associated with the first video image.

### cl CROSS-REFERENCE TO RELATED APPLICATION

This application is a continuation application of international application No. PCT/CN2020/110771, filed on Aug. 24, 2020, which claims priority to Chinese Patent Application No. 201910936022.1, filed on Sep. 29, 2019, the disclosures of which are herein incorporated by reference in their entireties,

### TECHNICAL FIELD

The present disclosure relates to the field of video processing technologies, and in particular,relates to a method for processing images and an electronic device therefor.

### BACKGROUND

For improvement of viewing effects of videos, it is often necessary to specifically process salient regions in video images, such as super-resolution reconstruction and image enhancement. The salient region herein refers to a region more noticeable by people in the video image.

lip the related art, in determination of the salient regions in the video images, the video images are generally subjected to visual saliency detection frame by frame using a salient region detection algorithm, such that the salient region in each video image is determined.

### SUMMARY

Embodiments of the present disclosure provide a method for processing images and an electronic device therefor.

According to one aspect of the embodiments of the present disclosure, a method for processing images is provided. The method includes: acquiring at least one first video image in a video to be processed, wherein a number of the first video images is less than a number of video images in the video to be processed; determining a first target region of the at least one first video image by performing region recognition on the at least one first video image; and determining, based on the first target region of the at least one first video image, a second target region of at least one second video image in the video to be processed other than the first video images, wherein the second video image is associated with the first video image.

According to another aspect of the embodiments of the present disclosure, an electronic device is provided. The electronic device includes: a processor; and a memory configured to store one or more instructions executable by the processor. The processor, when loading and executing the one or more instructions, is caused to: acquire at least one first video image in a video to be processed, wherein a number of the first video images is less than a number of video images in the video to be processed; determine a first target region of the at least one first video image by performing region recognition on the at least one first video image; and determine, based on the first target region of the at least one first video image, a second target region of at least one second video image in the video to be processed other than the first video images, wherein the second video image is associated with the first video image.

According to another aspect of the embodiments of the present disclosure, a non-transitory computer-readable storage medium is provided. The storage medium stores one or more instructions therein. The one or more instructions, when loaded and executed by a processor of an electronic device, cause the electronic device to: acquire at least one first video image in a video to be processed, wherein a number of the first video images is less than a number of video images in the video to be processed; determine a first target region of the at least one first video image by performing region recognition on the at least one first video image; and determine, based on the first target region of the at least one first video image, a second target region of at least one second video image in the video to be processed other than the first video images, wherein the second video image is associated with the first video image.

### BRIEF DESCRIPTION OF THE DRAWINGS

FIG. 1 is a flowchart of a method for processing images according to an embodiment of the present disclosure;

FIG. 2 is a flowchart of another method for processing images according to an embodiment of the present disclosure;

FIG. 3 is a flowchart of yet another method for processing images according to an embodiment of the present disclosure;

FIG. 4 is a schematic diagram of region detection according to an embodiment of the present disclosure;

FIG. 5 is a block diagram of an apparatus for processing images according to an embodiment of the present disclosure;

FIG. 6 is a block diagram of an electronic device for processing images according to an embodiment; and

FIG. 7 is a block diagram of an electronic device for processing images according to an embodiment.

### DETAILED DESCRIPTION

Exemplary embodiments of the present disclosure are described more clearly hereinafter with reference to the accompanying drawings. Although the exemplary embodiments of the present disclosure are shown in the drawings, it should be understood that the present disclosure can be implemented in various forms and should not be limited by the embodiments described herein. Rather, these embodiments are provided to ensure that the present disclosure is more thoroughly understood, and the scope of the present disclosure is fully conveyed to those skilled in the art.

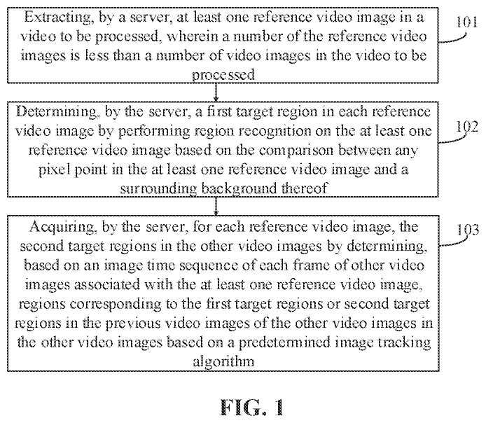

FIG. 1 is a flowchart of a method for processing images according to an embodiment of the present disclosure. As shown in FIG. 1, the method is applicable to an electronic device, wherein a server is taken as an example of the electronic device for illustration. The embodiment includes the following processes.

In 101, the server extracts at least one reference video image in a video to be processed.

Specifically, by process 101, the server may optionally acquire at least one first video image in the video to be processed, wherein a number of the first video images is less than a number of video images in the video to be processed. It should be noted that a video image in the video means an image frame in the video.

In some embodiments, the first video image refers to a video image determined by an equidistant or non-equidistant selection manner from the video to be processed. Because in process 102, the server needs to perform region recognition on the first video image to determine a first target region of the first video image, and then determine a second target region of a second video image by taking the first target region of the first video image as a criterion, the first video image is also referred to as the “reference video image.”

In some embodiments, the video to be processed is a video of which a target region needs to be determined. For example, assuming that the target region is a salient region, and image enhancement processing needs to be performed on the salient region of the video image in video A, the video A herein is determined as the video to be processed. In some embodiments, the reference video images are part of video images selected from the video to be processed, and a number of the reference video images is less than the number of the video images in the video to be processed.

In 102, the server determines the first target region in each reference video image by performing region recognition on the at least one reference video image based on the comparison between any pixel point in the at least one reference video image and a surrounding background thereof.

Specifically, by process 102, the server may optionally determine the first target region of the at least one first video image by performing region recognition on the at least one first video image.

In some embodiments, the server performs region recognition by comparing any pixel point in the reference video image with the surrounding background thereof based on a region detection algorithm. In some embodiments, the region detection algorithm is a salient region detection algorithm, and the first target region is a salient region of the first video image. For example, the server takes each reference video image as an input of the salient region detection algorithm, determines a saliency value of each pixel point in the reference video image through the salient region detection algorithm, and then outputs a saliency map, wherein the saliency value is a parameter determined based on the comparison between the color, brightness, and orientation of the pixel point and the surrounding background thereof, or based on the comparison of a distance between the pixel point and a pixel point in the surrounding background thereof. The way to determine the saliency value is not limited in the embodiment of the present disclosure.

In some embodiments, when generating the saliency map, the server performs multiple Gaussian blurs on the reference video image and performs down-sampling to generate multiple sets of images at different scales. For an image at each scale, color features, brightness features, and orientation features of the image are extracted to acquire a feature map at each scale. Next, each feature map is normalized and then convolved with a two-dimensional Gaussian difference function, and the convolution result is superimposed back to the original feature map. Finally, the saliency map is acquired by superimposing all the feature maps. For example, the saliency map is a grayscale map. Upon acquiring the saliency map, based on the saliency value of each pixel point in the saliency map, a region formed by pixel points with a saliency value greater than a predetermined threshold is divided from the reference video image, and the region is marked as the salient region.

In 103, for each reference video image, the server determines, based on the first target region in the reference video image, second target regions in other video images associated with the at least one reference video image in the video to be processed.

Specifically, by process 103, the server may optionally determine the second target region of at least one second video image in the video to be processed other than the first video images based on the first target region of the at least one first video image, wherein the second video image is associated with the first video image. It should be noted that each second video image is associated with one first video image, but one same first video image may be associated with one or more second video images.

Because the second video images are video images other than the first video images in the video to be processed, the second video images are also referred to as “other video images” or “non-reference video images.” In some embodiments, each first video image may be associated with one or more second video images.

It should be noted that the first target region refers to the salient region in the first video image, and the second target region refers to the salient region in the second video image, wherein the salient region refers to a region more likely to attract the attention of people in a video image.

In the embodiments of the present disclosure, each reference video image is associated with other video images, for example, the other video images associated with the reference video image are non-reference video images between one reference video image and another reference video image. Accordingly, all the reference video images and all other video images form the images of the video to be processed. Further, a difference between respective video images in the video is usually caused by relative changes of pixel points. For example, part of pixel points may be relatively moved in two adjacent video images, thus forming two different video images. Therefore, in the embodiments of the present disclosure, in the case that the first target regions in the first video images are determined, the second target regions in the second video images are determined based on the first target regions in these first video images and relative change information between respective pixel points in the first video images and respective pixel points in the associated second video images. In this way, there is no need to perform region recognition on the second video images using the salient region detection algorithm, thereby saving computing resources and time to some extent.

In the technical solution according to the embodiments of the present disclosure, at least one reference video image in the video to be processed is firstly extracted, wherein the number of the reference video images is less than the number of the video images in the video to be processed; then the first target region in each reference video image is determined by performing region recognition on the at least one reference video image based on the comparison between any pixel point in the reference video image and the surrounding background thereof; and finally, for each reference video image, the second target regions in other video images associated with the at least one reference video image in the video to be processed are determined based on the first target region in the reference video image. In the embodiments of the present disclosure, the region recognition only needs to be performed on part of video images (that is, the reference video images) in the video to be processed based on the comparison between any pixel point in the reference video images and the surrounding background thereof, and the second target regions in other video images are determined based on the first target regions in these reference video images. In this way, there is no need to perform region recognition on all video images based on the comparison between any pixel point in the video images and the surrounding background thereof. Therefore, the computing resources and time consumed for determining the salient regions in respective video images are reduced to some extent, and the efficiency of determining the salient regions is improved.

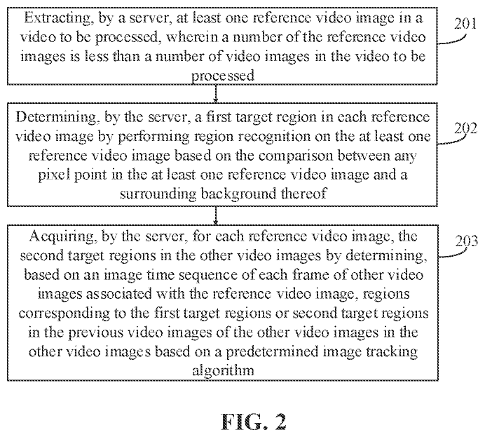

FIG. 2 is a flowchart of another method for processing images according to an embodiment of the present disclosure. As shown in FIG. 2, the method is applicable to an electronic device, wherein a server is taken as an example of the electronic device for illustration. The embodiment includes the following processes.

In 201, the server extracts at least one reference video image in a video to be processed, wherein a number of the reference video images is less than a number of video images in the video to be processed.

Specifically, by process 201, the server may optionally acquire at least one first video image in the video to be processed, wherein a number of the first video images is less than the number of the video images in the video to be processed. It should be noted that a video image in the video means an image frame in the video.

In one practice for determining the first video image, the at least one first video image is acquired by selecting, starting from a first frame in the video to be processed, one first video image every N frames, wherein N is an integer greater than or equal to 1. The smaller N is, the more the video images needing to be recognized based on the comparison between any pixel point in the video images and a surrounding background thereof are, that is, the more the video images needing to be recognized based on the region detection algorithm are, and the more the required computing time and resources are. However, the smaller N is, the less the number of the second video images associated with the first video image tends to be, and in this case, the higher the determining accuracy of the second target region tends to be. On the contrary, the larger N is, the less the video images needing to be recognized based on the comparison between any pixel point in the video images and the surrounding background thereof are, and the less the required computing time and resources are. However, the larger N is, the more the number of the second video images associated with the first video image tends to be, such that the lower the determining accuracy of the second target region possibly tends to be. Therefore, a specific value of N is set depending on actual needs, for example, N is 5 or other values, which is not limited in the embodiments of the present disclosure. Exemplarily, assuming that the video image to be processed includes 100 video images, in the case that N=5, the first video image, the sixth video image, the 11th video image, . . . , and the 96th video image are taken as the first video images, and a total of 20 first video images are acquired.

In the embodiment of the present disclosure, the selection is performed every constant frames, such that the number of other video images associated with each reference video image is constant. In this way, the case, in which some reference video images are associated with too many other video images thereby resulting in the inaccuracy of the second target regions in other video images determined based on the first target regions in reference video images, is avoided, thereby improving the effect of region determination.

In another practice for determining the reference video image, at least one video image is freely selected from the video images in the video to be processed as the at least one first video image. Exemplarily, one video image is firstly selected at an interval of 2 frames, then one video image is selected at an interval of 5 frames, then one video image is selected at an interval of 4 frames, and so on. Finally, the selected video images are taken as the at least one first video image. In this implementation, the selection is performed at a random interval of any number of frames each time, without the limitation of the predetermined value N, that is, the selection is performed non-equidistantly, thereby improving the flexibility of the selection operation for the first video image.

In 202, the server determines the first target region in each reference video image by performing region recognition on the at least one reference video image based on the comparison between any pixel point in the at least one reference video image and the surrounding background thereof.

Specifically, by process 202, the server may optionally determine the first target region of the at least one first video image by performing region recognition on the at least one first video image.

For details about process 202, reference may be made to process 102, which are not repeated in detail herein in the embodiment of the present disclosure.

In 203, for each reference video image, based on an image time sequence of each of other video images associated with the at least one reference video image, the server acquires the second target regions in the other video images by determining, based on a predetermined image tracking algorithm, regions corresponding to the first target regions or the second target regions in the previous video images of the other video images in the other video images.

In some embodiments, when determining the second target region, the server determines, based on time sequences of the video images in the video to be processed, the at least one second video image associated with the at least one first video image, wherein a time sequence of the second video image is between one first video image and a next first video image.

The time sequences of the video images represent a chronological order in which the video images appear in the video to be processed. Exemplarily, assuming that video image a appears in the 10th second of the video to be processed, video image b appears in the 30th second of the video to be processed, and video image c appears in the 20th second of the video to be processed, then the image time sequence of the video image a is earlier than the image time sequence of the video image c, and the image time sequence of the video image c is earlier than the image time sequence of the video image b.

In some embodiments, the server acquires all video images between one first video image and the next first video image as the at least one second video image. Optionally, the server randomly selects part of the video images from all the video images between one first video image and the next first video image as the at least one second video image.

In some embodiments, upon determining the respective second video images, the server acquires the second target regions of the at least one second video image by performing image tracking on the first target regions of the at least one first video image.

In some embodiments, all video images between one first video image and the next first video image thereof are determined as the at least one second video image. Next, the second target region of a first frame of second video image is acquired by performing image tracking on the first target region of the first video image, the second target region of a second frame of second video image is acquired by continuously performing image tracking on the second target region of the first frame of second video image, and so on, such that the second target regions of various second video images can be acquired by tracking.

In some embodiments, the other video images associated with the at least one reference video image are non-reference video images between any reference video image and the next reference video image thereof. In these other video images, the previous video image of a frame of the other video images with the earliest image time sequence is the reference video image. Therefore, the region corresponding to the first target region in the reference video image in the frame of the other video images is determined, based on the predetermined image tracking algorithm, by tracking the first target region in the reference video image, such that the second target region of the frame of the other video images is acquired, and then the second target region of a next frame of the other video images whose image time sequence is only later than the frame of the other video images is determined by tracking the second target region of the frame of the other video images.

In some embodiments, the predetermined tracking algorithm is an optical flow tracking algorithm. The optical flow tracking algorithm is based on a brightness constancy principle, that is, brightness of a same point does not change with time, as well as a space consistency principle, that is, an adjacent pixel point of one pixel point projected onto a next image is also an adjacent pixel point of the pixel point, and the pixel point and its adjacent pixel point are consistent in moving speed between two adjacent images. Based on brightness features of the pixel points and speed features of the adjacent pixel points of the pixel points in the first target regions or the second target regions in the previous video images, the second target regions in the other video images are acquired by predicting pixel points, corresponding to these pixel points in the previous video images, in the other video images. In the embodiments of the present disclosure, the target regions in other video images can be determined only by taking the previous video images as inputs of the predetermined tracking algorithm, thereby to some extent improving the efficiency of determining the target regions in other video images. Optionally, in the case that the previous video image is the first video image, the first target region of the first video image needs to be tracked, and in the case that the previous video image is the second video image with an earlier time sequence, the second target region of the second video image needs to be tracked.

The difference between adjacent video images is often made small, such that in the case that the target regions are sequentially determined based on image time sequences, the difference between the image to be tracked each time and its last image is small, and further the corresponding regions can be accurately acquired by tracking based on the tracking algorithm to some extent, thereby improving the efficiency of determining the target region.

In the technical solution according to the embodiments of the present disclosure, at least one reference video image in the video to be processed is firstly extracted, wherein the number of the reference video images is less than the number of the video images in the video to be processed; then based on the comparison between any pixel point in the reference video image and the surrounding background thereof, the first target region in each reference video image is determined by performing the region recognition on the at least one reference video image; and finally, for other video images associated with each reference video image, based on the image time sequence of each frame of other video images, the second target regions in the other video images are acquired by determining the corresponding regions, of the first target regions or the second target regions in the previous video images of the other video images, in the other video images based on the predetermined image tracking algorithm. In the embodiments of the present disclosure, the region recognition only needs to be performed, based on the comparison between any pixel point in the reference video images and the surrounding background thereof, on part of video images (that is, the reference video images) in the video to be processed, and the second target regions in other video images are determined based on the first target regions in these reference video images. In this way, there is no need to perform region recognition on all video images based on the comparison between any pixel point in the video images and the surrounding background thereof. Therefore, the computing resources and time consumed for determining the salient regions in various video images are reduced to some extent, and the efficiency of determining the salient regions is improved.

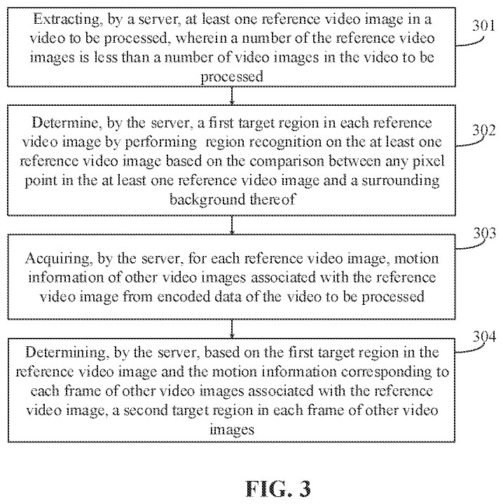

FIG. 3 is a flowchart of another method for processing images according to an embodiment of the present disclosure. As shown in FIG. 301, the method is applicable to an electronic device, wherein a server is taken as an example of the electronic device for illustration. The embodiment includes the following processes.

In 301, the server extracts at least one reference video image in a video to be processed; wherein a number of the reference video images is less than a number of video images in the video to be processed.

Specifically, by process 301, the server may optionally acquire at least one first video image in the video to be processed, wherein a number of the first video images is less than the number of the video images in the video to be processed. It should be noted that a video image in the video means an image frame in the video.

For details about process 301, reference may be made to process 201, which are not limited in the embodiments of the present disclosure.

In 302, the server determines a first target region in each reference video image by performing region recognition on the at least one reference video image based on the comparison between any pixel point in the at least one reference video image and a surrounding background thereof.

Specifically, by process 302, the server may optionally determine the first target region of the at least one first video image by performing region recognition on the at least one first video image.

For details about process 302, reference may be made to process 202, which are not repeated in detail in the embodiment of the present disclosure.

In 303, for each reference video image, the server acquires motion information of other video images associated with the at least one reference video image from encoded data of the video to be processed.

In some embodiments, in a first encoding process, the encoded data refers to first encoded data, and in a re-encoding process, the encoded data refers to re-encoded data.

Specifically, by process 303, the server may optionally acquire motion information of at least one second video image, wherein one second video image is associated with one first video image.

The motion information of the second video image includes a displacement amount and a displacement direction of each pixel point in a plurality of video image blocks of the second video image relative to a corresponding pixel point in a previous video image.

In some embodiments, when encoding the video to be processed, each key frame image in the video to be processed is usually extracted, and for each key frame image, the displacement amounts and displacement directions of respective pixel points in a plurality of adjacent non-key frame images behind the key frame image relative to the corresponding pixel points in the key frame image are acquired, such that the motion information is acquired. Finally, the key frame images and the motion information of the non-key frame images are taken as the encoded data. Therefore, in the embodiments of the present disclosure, the motion information of other video images is acquired from the encoded data of the video to be processed, to facilitate recognition based on such information in the subsequent process.

In some embodiments, before the motion information corresponding to other video images is acquired, the encoded data corresponding to the video to be processed is acquired. In an on-demand scenario of video streaming media, when uploading the video to be processed to the server by a video producer, the video to be processed is usually encoded once, that is, the video to be processed is a video that has been encoded for the first time. Therefore, the motion information of the at least one second video image is acquired from the first encoded data of the video to be processed.

In some embodiments, a video platform may have a customized video encoding standard, accordingly, the video platform may re-encode the received video to be processed based on the customized video encoding standard. Therefore, the re-encoded data of the video to be processed is acquired by re-encoding the video to be processed, and the motion information of the at least one second video image is acquired from the re-encoded data. In some embodiments, the re-encoding operation means re-encoding content in the last encoded data based on the last encoded data of the video to be processed. A data volume of the content of the last encoded data is less than a data volume of the content of the video to be processed. Therefore, by re-encoding the last encoded data, the occupation of processing resources can be reduced to some extent, thereby avoiding the problem of stalling.

In 304, the server determines, based on the first target region in the reference video image and the motion information corresponding to each frame of other video images associated with the at least one reference video image, a second target region in each frame of other video images.

Specifically, by process 304, the server may optionally determine the second target region of the at least one second video image based on the first target region of the at least one first video image and the motion information of the at least one second video image.

The motion information can reflect relative changes of the pixel points between the video images. Therefore, in the embodiments of the present disclosure, in combination with the first target region in the reference video image and the motion information corresponding to other video images, the second target regions in other video images can be determined. In this way, the first target regions in only part of video images (that is, the reference video images) in the video to be processed need to be determined based on the comparison between any pixel point in the reference video images and the surrounding background thereof, and then the second target regions in other video images is determined in combination with the motion information corresponding to other video images. Herein, both the first target region and the second target region are referred to as “salient regions.” Therefore, the efficiency of determining the salient regions in all video images in the video to be processed is improved to some extent.

In some embodiments, process 304 is performed through the following sub-processes (1) to (4):

In (1), the server divides, based on an image time sequence of each frame of other video images associated with the at least one reference video image, each frame of the other video images into multiple video image blocks.

In other words, for each first video image, each second video image associated with the first video image is divided into multiple video image blocks.

In some embodiments, the other video images are divided into multiple video image blocks of a predetermined size according to a predetermined size, wherein a specific value of the predetermined size is determined depending on actual requirements. The smaller the predetermined size is, the more the video image blocks are, and accordingly, the more accurate the second target regions determined based on the video image blocks are, but more processing resources are consumed. The larger the predetermined size is, the less the video image blocks are, and accordingly, the lower the accuracy of the second target regions determined based on the video image blocks is, but fewer processing resources are consumed.

In (2), for each video image block, in the case that the motion information includes motion information corresponding to the video image block, the server determines, based on the motion information corresponding to the video image block, a region, corresponding to the video image block, in the previous video image of the video image block.

In some embodiments, the previous video image may be the reference video image, that is, the first video image, or other video images, that is, the second video images. For example, one first video image is selected from the video to be processed every 5 frames, and at this time, both the first and sixth frames are the first video images, the second, third, fourth, and fifth frames are selected as the second video images. In the case that the second video image currently processing is the second frame, it is obvious that the previous frame (i.e., the first frame) of the second frame is the first video image, and in the case that the second video image currently processing is the third frame, it is obvious that the previous frame (i.e., the second frame) of the third frame is the second video image.

The motion information corresponding to the video image block includes the displacement amount and the displacement direction of each pixel point in the video image block relative to the corresponding pixel point in the previous video image. In some embodiments, a problem of missing the motion information may occur. Therefore, it is first determined whether the motion information includes the motion information corresponding to the video image block. In the case that the motion information includes the motion information corresponding to the video image block, the region corresponding to the video image block in the previous video image is determined based on the motion information corresponding to the video image block.

In some embodiments, the other video images associated with a reference video image are the video images between the reference video image and a next reference video image thereof, that is, the image time sequences of other video images associated with the reference video image are all later than the image time sequence of the reference video image.

The motion information corresponding to the video image block includes the displacement amount and displacement direction of each pixel point in the video image block relative to the corresponding pixel point in the previous video image. Therefore, for determining the region, corresponding to the video image block, in the previous video image, based on the displacement amount and displacement direction of each pixel point in the video image block relative to the corresponding pixel point in the previous video image, position coordinates of each pixel point in the video image block are moved by the displacement amount in an opposite direction to the displacement direction of each pixel point, to acquire the position coordinates of each moved pixel point, and then the region formed by the position coordinates of the corresponding moved pixel point (of each pixel point) in the previous video image is determined as the corresponding region. Exemplarily, the displacement amount is a coordinate value, and the positivity and negativity of the coordinate value indicate different displacement directions. In this way, the position coordinates of each pixel point in the video image block are moved based on the displacement amount and displacement direction corresponding to each pixel point in the video image block (which is equivalent to perform once mapping of the position coordinates), such that the video image block is mapped to the previous video image, and then the region corresponding to the video image block is acquired.

In (3), in the case that the corresponding region is in the first target region or the second target region of the previous video image, the server determines the video image block as a constituent part of the target regions of other video images.

In some embodiments, it is determined whether the corresponding region falls within the first target region or the second target region (all referred to as the “salient region”) of the previous video image, in the case that the region determined in (2) is in the first target region or the second target region of the previous video image, it is considered that the content of the video image block is the content in the salient region of the previous video image, and accordingly, the video image block is determined as the constituent part of the target regions of the other video images.

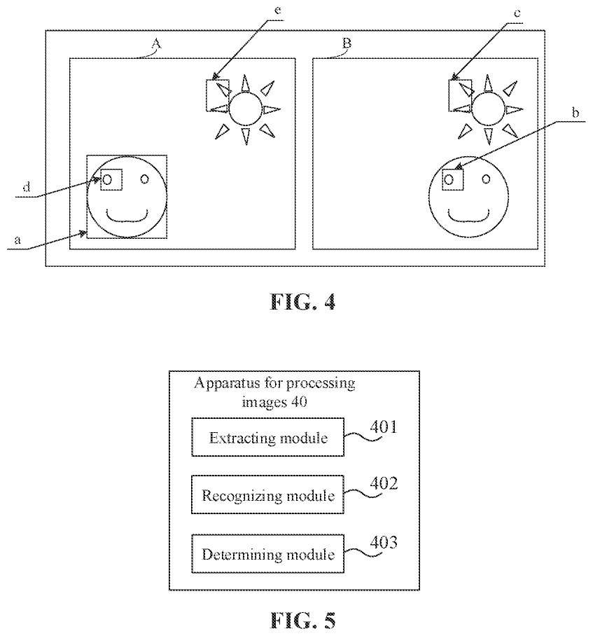

Exemplarily, FIG. 4 is a schematic diagram of region detection according to an embodiment of the present disclosure. As shown in FIG. 4, A represents the previous video image in which the salient region has been determined, and B represents other video images, wherein region a represents the salient region in the previous video image. In the case that the previous video image is the first video image, the salient region refers to the first target region, and in the case that the previous video image is the second video image, the salient region is the second target region. Region b represents one video image block in other video images, region c represents another video image block in other video images, region d is a region corresponding to region b in the previous video image, and region e is a region corresponding to region c in the previous video image. It can be seen that region d is in the salient region of the previous video image, and region e is not located in the salient region of the previous video image. Therefore, the video image block represented by region b is determined as a constituent part of the target region. In the embodiments of the present disclosure, for determining the constituent parts of various target regions of the second target regions in the other video images, it is only needed to determine, based on the motion information, whether the regions corresponding to the video image blocks of other video images are located in the salient regions of the previous video images. In this way, region recognition for all video images is achieved by performing the region recognition only on part of video images (that is, the reference video images) in the video to be processed based on the comparison between any pixel point in the reference video images and the surrounding background thereof. Therefore, the computing resources and time consumed for determining the salient regions in various video images are reduced to some extent, and the efficiency for determining the salient regions is improved.

In some embodiments, in the case that the motion information does not include the motion information corresponding to the video image block, it is determined whether the adjacent image block of the video image block is a constituent part of the target regions of other video images. In other words, in the case of missing the motion information of a specific video image block, the operations in sub-processes (2) and (3) are performed to the adjacent image block of the video image block, to determine whether the adjacent image block is a constituent part of the target regions, and the determination result of the adjacent image blocks is acquired as the determination result of the video image block.

In the case that the adjacent image block of the video image block is a constituent part of the target regions, the video image block is determined as the constituent part of the target regions of the other video images. The adjacent image block of the video image block is image block adjacent to the video image block, and the adjacent image block is any adjacent image block. In the case that the adjacent image block of the video image block is a constituent part of the target regions of the other video images, it is considered that the video image block also belongs to the constituent part of the target region with a high probability. Therefore, the determination is directly performed based on the adjacent image block. In this way, for the video image block missing motion information, it can also be quickly determined whether the video image block is the constituent part of the target region, thereby ensuring the efficiency of detecting the target region.

In (4), the server determines the regions formed by all the constituent parts as the second target regions of the other video images.

Assuming that the regions corresponding to three video image blocks in the other video images are located in the salient regions of the previous video images, then the regions formed by these three video image blocks are the second target regions of the other video images.

Further, it is assumed that the reference video image is image X, and other associated video images are image Y and image Z respectively, wherein the image time sequence of image X is the earliest, the image time sequence of image Y is second, and the image time sequence of image Z is the last. Based on motion information of image Y, the region, corresponding to each video image block in image Y, in image X is determined, the region formed by the video image blocks whose corresponding regions are within the salient region of image X (the previous image X is the reference video image, that is, the first video image, such that the salient region refers to the first target region) is determined as the salient region in image Y, such that the second target region in image Y is acquired. Next, the region, corresponding to each video image block in image Z, in image Y is determined, the region formed by the video image blocks whose corresponding region is within the salient region of image Y (the previous image Y is the second video image, such that the salient region refers to the second target region) is determined as the salient region in image Z, such that the second target region in image Z is acquired.

In some embodiments, process 304 is performed by the following sub-processes 3041 to 3043.

In 3041, the server acquires the displacement direction and displacement amount of each pixel point in each video image block from the motion information of the second video image.

Because the motion information of the second video image stores the motion information of multiple video image blocks in the second video image, by reading the motion information of each video image block stored in the motion information of the second video image, the displacement direction and the displacement amount of each pixel point in each video image block can be acquired.

In 3042, based on the displacement direction and displacement amount, the server maps each pixel point from the second video image to the previous video image of the second video image, and determines a region formed by various mapped pixel points as a mapping region.

In the above process, for each pixel point in the video image block, the displacement direction and the displacement amount of the pixel point stored in the motion information refer to how the pixel point is mapped from the previous video image to the current second video image. Therefore, positions of the corresponding pixel points of various pixel points in the video image blocks in the previous video images can be determined only by performing inverse mapping, that is, various pixel points in the video image blocks are mapped to the previous video image, and the region formed by various mapped pixel points is determined as the mapping region.

The server performs sub-processes 3041 and 3042 on each video image block stored in the motion information, which is equivalent to that the server determines, based on the motion information of the second video image, the mapping region, corresponding to multiple video image blocks in the motion information, in the previous video image of the second video image.

In 3043, the server acquires target video image blocks, and determines a region formed by the target video image blocks as the second target region of the second video image, wherein the mapping region of the target video image block is in the first target region or the second target region of the previous video image.

In the above process, the server firstly acquires the mapping region, of each video image block, in the previous video image by mapping each pixel point in each video image block stored in the motion information, and then acquires the target video image block of which the mapping region is in the salient region of the previous video image, which is equivalent to that the target video image block is screened out from various video image blocks according to whether the mapping region is in the salient region. Optionally, in the case that the previous video image is the first video image, the salient region refers to the first target region, and in the case that the previous video image is the second video image, the salient region refers to the second target region, that is, depending on different types of previous video images, there are different types of salient regions.

In some embodiments, because the motion information only records the motion information of the video image blocks of which the pixel point positions are moved in adjacent video images, in the case that some video image blocks are not moved, the motion information of these video image blocks is not recorded in the motion information of the second video image, but these unmoved video image blocks may still be in the second target region of the current second video image. Therefore, by determining whether the adjacent video image blocks of these unmoved video image blocks are the target video image blocks, it can be determined whether these unmoved video image blocks are the target video image blocks.

In some embodiments, in the case that the motion information of some video image blocks is not recorded in the motion information of the second video image, the server executes the following operations: dividing the second video image into multiple video image blocks; for any video image block, in the case that the motion information of the second video image does not include the motion information of the video image block, determining whether the mapping region of an adjacent image block of the video image block is in the first target region or the second target region of the previous video image; and in the case that the mapping region of the adjacent image block is in the first target region or the second target region of the previous video image, determining the video image block as a target video image block.

In the above process, for the video image block not recorded in the motion information of the second video image, it can be determined whether the video image block is the target video image block only by determining whether the mapping region of the adjacent image block is in the salient region of the previous video image, wherein the manner of determining whether the mapping region of the adjacent image block is in the salient region of the previous video image is similar to the above processes 3041-3043, and is not repeated herein.

In summary, in the technical solution according to the embodiments of the present disclosure, at least one reference video image in the video to be processed is firstly extracted, wherein the number of the reference video images is less than the number of the video images in the video to be processed. Next, the first target region in each reference video image is determined by performing the region recognition on the at least one reference video image based on the comparison between any pixel point in the reference video image and the surrounding background thereof. Then, for each reference video image, the motion information corresponding to other video images associated with the reference video image is acquired from the encoded data corresponding to the video to be processed. Finally, the second target region in each frame of other video images is determined based on the first target region in the reference video image and the motion information corresponding to each frame of other video images associated with the reference video image. In this way, the salient regions in all video images in the video to be processed can be determined without the need to perform region recognition on all video images based on the comparison between any pixel point in the video images and the surrounding background thereof. Therefore, the computing resources and time consumed for determining the salient regions in various video images are reduced to some extent, and the efficiency of determining the salient regions is improved.

FIG. 5 is a block diagram of an apparatus for processing images according to an embodiment of the present disclosure. As shown in FIG. 5, the apparatus 40 includes an extracting module 401, a recognizing module 402, and a determining module 403.

The extracting module 401 is configured to extract at least one reference video image in a video to be processed, wherein a number of the reference video images is less than a number of video images in the video to be processed.

In some embodiments, the reference video image is also referred to as a first video image.

In some embodiments, the extracting module 401 is configured to acquire at least one first video image in the video to be processed, wherein the number of the first video images is less than the number of the video images in the video to be processed.

In some embodiments, the recognizing module 402 is configured to determine a first target region in each reference video image by performing region recognition on the at least one reference video image based on the comparison between any pixel point in the at least one reference video image and a surrounding background thereof.

In some embodiments, the identifying module 402 is configured to determine the first target region of the at least one first video image by performing region recognition on the at least one first video image.

In some embodiments, the determining module 403 is configured to determine, for each reference video image, based on the first target region in the reference video image, second target regions in other video images associated with the reference video image in the video to be processed.

In some embodiments, the determining module 403 is configured to determine, based on the first target region of the at least one first video image, the second target region of the at least one second video image in the video to be processed other than the first video images, wherein the second video image is associated with the first video image.

In the technical solution according to the embodiments of the present disclosure, at least one reference video image in the video to be processed is firstly extracted, wherein the number of the reference video images is less than the number of the video images in the video to be processed. Next, the first target region in each reference video image is determined by performing the region recognition on the at least one reference video image based on the comparison between any pixel point in the reference video image and the surrounding background thereof. Finally, for each reference video image, the second target regions in other video images associated with the reference video image in the video to be processed are determined based on the first target region in the reference video image. In the embodiments of the present disclosure, the region recognition only needs to be performed on part of video images (that is, the reference video images) in the video to be processed based on the comparison between any pixel point in the reference video images and the surrounding background thereof, and the second target regions in other video images are determined based on the first target regions in these reference video images. In this way, there is no need to perform region recognition on all video images based on the comparison between any pixel point in the video images and the surrounding background thereof. Therefore, the computing resources and time consumed for determining the salient regions in various video images are reduced to some extent, and the efficiency of determining the salient regions is improved.

In some embodiments, the extracting module 401 is configured to acquire the at least one first video image by selecting, starting from a first frame in the video to be processed, one first video image every N frames, wherein N is an integer greater than or equal to 1; or, freely select at least one video image from the video images in the video to be processed as the at least one first video image.

In some embodiments, the determining module 403 is configured to acquire the second target regions in the other video images by determining, based on an image time sequence of each frame of other video images associated with the reference video image, for each frame of other video images, the regions corresponding to the first target regions or the second target regions in the previous video images of the other video images in the other video images using a predetermined image tracking algorithm, wherein the previous video image with the earliest image time sequence of the other video images is the reference video image.

In some embodiments, the determining module 403 is configured to determine, based on time sequences of the video images in the video to be processed, the at least one second video image associated with the first video image, wherein a time sequence of the second video image is between one first video image and a next first video image; and acquire the second target region of the at least one second video image by performing image tracking on the first target region of the at least one first video image.

In some embodiments, the determining module 403 is configured to acquire motion information corresponding to other video images associated with the at least one reference video image from encoded data of the video to be processed; and determine, based on the first target region in the reference video image and the motion information corresponding to each frame of other video images associated with the reference video image, the second target region in each frame of other video images.

In some embodiments, the determining module 403 is configured to acquire motion information of the at least one second video image, the motion information of the second video image including a displacement amount and a displacement direction of each pixel point in a plurality of video image blocks relative to a corresponding pixel point in a previous video image; and determine, based on the first target region of the at least one first video image and the motion information of the at least one second video image, the second target region of the at least one second video image.

In some embodiments, the determining module 403 is further configured to divide, for each frame of other video images, the other video image into multiple video image blocks based on the image time sequence of each frame of the other video images associated with the reference video image; for each video image block, in the case that the motion information includes motion information corresponding to the video image block, determine, based on the motion information corresponding to the video image block, a region corresponding to the video image block in the previous video image of the other video image; determine, in the case that the corresponding region is in the first target region or the second target region of the previous video image, the video image block as a constituent part of the target regions of other video images; and determine the regions formed by all the constituent parts as the second target regions of the other video images. The motion information includes the displacement amount and displacement direction of each pixel point in the video image block relative to the corresponding pixel point in the previous video image.

In some embodiments, the determining module 403 is further configured to determine, based on the motion information of the second video image, mapping regions of the plurality of video image blocks in the previous video image of the second video image; and acquire target video image blocks, and determine the region formed by the target video image blocks as the second target region of the second video image, wherein the mapping region of the target video image block is in the first target region or the second target region of the previous video image.

In some embodiments, the determining module 403 is further configured to determine, in the case that the motion information does not include the motion information corresponding to the video image block, whether an adjacent image block of the video image block is a constituent part of the target regions of other video images; and in the case that the adjacent image block of the video image block is a constituent part of the target regions, determine the video image block as the constituent part of the target regions of other video images.

In some embodiments, the determining module 403 is further configured to divide the second video image into multiple video image blocks; determine, for any video image block, in the case that the motion information of the second video image does not include motion information of the video image block, whether the mapping region of the adjacent image block of the video image block is in the first target region or the second target region of the previous video image; and determine, in the case that the mapping region of the adjacent image block is in the first target region or the second target region of the previous video image, the video image block as a target video image block.

In some embodiments, in the case that the video to be processed is an encoded video, the determining module 403 is further configured to take the encoded data of the video to be processed as the encoded data corresponding to the video to be processed; or acquire re-encoded data of the video to be processed by re-encoding the video to be processed, and take the re-encoded data as the encoded data corresponding to the video to be processed. Optionally, the other video images associated with the reference video image are video images between the reference video image and the next reference video image.

In some embodiments, the extracting module 401 is also configured to acquire the motion information of the at least one second video image from first encoded data of the video to be processed; or acquire the re-encoded data of the video to be processed by re-encoding the video to be processed, and acquire the motion information of the at least one second video image from the re-encoded data.

In some embodiments, the determining module 403 is further configured to move, for each pixel point in the video image block, each pixel point by the displacement amount in an opposite direction to the displacement direction of the pixel point in the video image block; and determine a region formed by the corresponding pixel point of each moved pixel point in the previous video image as the corresponding region.

In some embodiments, the determining module 403 is further configured to acquire, from the motion information of the second video image, the displacement direction and the displacement amount of each pixel point in each video image block; and map, based on the displacement direction and the displacement amount, each pixel point in each video image block from the second video image to the previous video image, and determine the region formed by mapped pixel points as one mapping region.

Regarding the apparatus in the above embodiment, the modules and the operations performed the modules have been described in detail in the method embodiments, which are not described in detail herein.

An embodiment of the present disclosure further provides an electronic device. The electronic device includes a processor and a memory configured to store one or more instructions executable by the processor. The processor, when loading and executing the one or more instructions, is caused to perform the method for processing images as defined in any of the above embodiments.

An embodiment of the present disclosure further provides a non-transitory computer-readable storage medium. The storage medium stores one or more instructions. The one or more instructions, when loaded and executed by a processor of an electronic device, cause the electronic device to perform the method for processing images as defined in any of the above embodiments.

An embodiment of the present disclosure further provides a computer program product. The computer program product includes a computer program. The computer program, when loaded and run by a processor of an electronic device, causes the electronic device to perform the method for processing images as defined in any of the above embodiments.

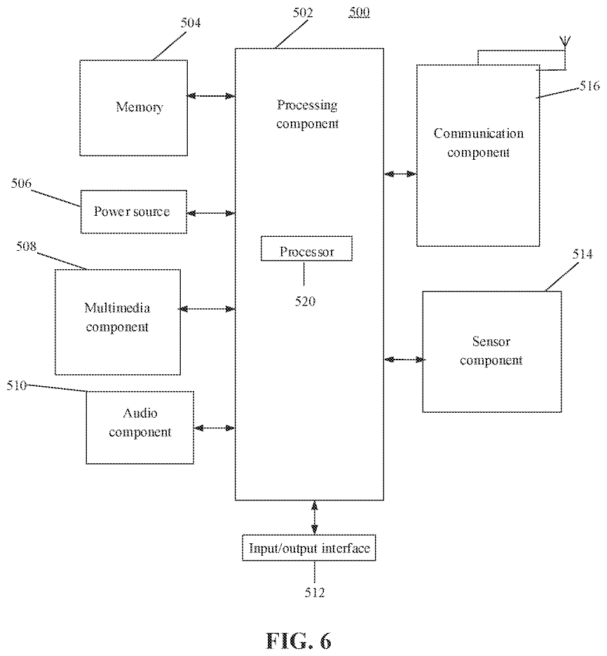

FIG. 6 is a block diagram of an electronic device for processing images according to an embodiment. For example, the electronic device 500 includes a mobile phone, a computer, a digital broadcast terminal, a message receiving and sending device, a game console, a tablet device, a medical device, a fitness device, a personal digital assistant, and the like.

Referring to FIG. 6, the electronic device 500 includes one or more of: a processing component 502, a memory 504, a power source 506, a multimedia component 508, an audio component 510, an input/output (I/O) interface 512, a sensor component 514, and a communication component 516.

The processing component 502 typically controls overall operations of the device 500, such as the operations associated with display, telephone calls, data communications, camera operations, and recording operations. The processing component 502 includes one or more processors 520 to execute instructions to finish all or part of operations in the above methods for processing images. Moreover, the processing component 502 includes one or more modules to facilitate the interaction between the processing component 502 and other components. For instance, the processing component 502 includes a multimedia module to facilitate the interaction between the multimedia component 508 and the processing component 502.

The memory 504 is configured to store various types of data to support the operation on the electronic device 500. Examples of such data include instructions for any application programs or methods operated on the electronic device 500, such as contact data, phonebook data, messages, pictures, and videos. The memory 504 is implemented by any type of volatile or non-volatile memory devices, or a combination thereof, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic, or optical disk.

The power source 506 provides power to various components of the device 500. The power source 506 includes a power management system, one or more power sources, and other components associated with the generation, management, and distribution of power in the electronic device 500.

The multimedia component 508 includes a screen providing an output interface between the electronic device 500 and a user. In some embodiments, the screen includes a liquid crystal display (LCD) and a touch panel (TP). In the case that the screen includes the touch panel, the screen is implemented as a touch screen to receive an input signal from the user. The touch panel includes one or more touch sensors to sense touch, swipe, and gestures on the touch panel. The touch sensor not only senses the boundary of a touch or swipe action, but also detects the duration and pressure associated with the touch or swipe action. In some embodiments, the multimedia component 508 includes a front camera and/or a rear camera. The front camera and/or the rear camera receive external multimedia data in the case that the electronic device 500 is in an operation mode, such as a shooting mode or a video mode. Each of the front camera and the rear camera is a fixed optical lens system or has a focus and optical zoom capability.

The audio component 510 is configured to output and/or input audio signals. For example, the audio component 510 includes a microphone (MIC) configured to receive an external audio signal in the case that the electronic device 500 is in an operation mode, such as a call mode, a recording mode, and a voice recognition mode. The received audio signal is further stored in the memory 504 or transmitted via the communication component 516. In some embodiments, the audio component 510 also includes a speaker for outputting an audio signal.

The I/O interface 512 provides an interface between the processing component 502 and peripheral interface modules, wherein the peripheral interface modules include a keyboard, a click wheel, and buttons. The buttons include, but are not limited to, a home button, a volume button, a starting button, and a locking button.

The sensor component 514 includes one or more sensors to provide status assessments of various aspects of the electronic device 500. For instance, the sensor component 514 detects an open/closed status of the electronic device 500, and relative positions of components. For example, the component includes the display and the keypad of the electronic device 500, and the sensor component 514 is further configured to detect a change in position of the electronic device 500 or a component of the electronic device 500, the contact between a user and the electronic device 500, an orientation or an acceleration/deceleration status of the electronic device 500, and a temperature change of the electronic device 500. The sensor component 514 further includes a proximity sensor configured to detect the presence of nearby objects without any physical contact. The sensor component 514 also includes a light sensor, such as a CMOS or CCD image sensor, for use in imaging applications. In some embodiments, the sensor component 514 also includes an accelerometer sensor, a gyroscope sensor, a magnetic sensor, a pressure sensor, or a temperature sensor.

The communication component 516 is configured to facilitate communication, wired or wirelessly, between the electronic device 500 and other devices. The electronic device 500 accesses a wireless network based on a communication standard, such as WiFi, a service provider's network (2G, 3G, 4G, or 5G), or a combination thereof. In one exemplary embodiment, the communication component 516 receives a broadcast signal or broadcast associated information from an external broadcast management system via a broadcast channel. In one exemplary embodiment, the communication component 516 further includes a near-field communication (NFC) module to facilitate short-range communications. For example, the NFC module is implemented based on a radio frequency identification (RFID) technology, an infrared data association (IrDA) technology, an ultra-wideband (UWB) technology, a Bluetooth (BT) technology, and other technologies.

In exemplary embodiments, the electronic device 500 is implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above methods for processing images.

An embodiment of the present disclosure further provides a non-transitory computer-readable storage medium including one or more instructions therein is also provided, such as the memory 504 including one or more instructions. The above one or more instructions, when executed by the processor 520 of the electronic device 500, cause the electronic device 500 to perform the above methods for processing images. For example, the non-transitory computer-readable storage medium may be a ROM, a random-access memory (RAM), a compact disc read-only memory (CD-ROM), a magnetic tape, a floppy disc, an optical data storage device, or the like.

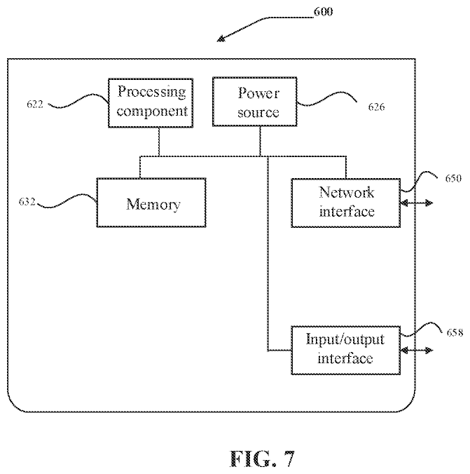

FIG. 7 is a block diagram of an electronic device 600 for processing images according to an embodiment. For example, the electronic device 600 is provided as a server. Referring to FIG. 7, the electronic device 600 includes a processing component 622 that further includes one or more processors, and memory resources represented by a memory 632 configured to store one or more instructions executable by the processing component 622, such as an application program. The application program stored in the memory 632 includes one or more modules each corresponding to a set of instructions. Further, the processing component 622, when executing the one or more instructions, is caused to perform the above methods for processing images.

The electronic device 600 also includes a power source 626 configured to execute power management for the electronic device 600, a wired or wireless network interface 650 configured to connect the electronic device 600 to a network, and I/O interface 658. The electronic device 600 can operate an operating system stored in the memory 632. The operating system includes, but is not limited to, Windows Server, Mac OS X, Unix, Linux, FreeBSD, or the like.

All the embodiments of the present disclosure can be executed individually or in combination with other embodiments, which are all within a protection scope claimed by the present disclosure.

What is claimed is:

1. A method for processing images, comprising:
acquiring at least one first video image in a video to be processed, wherein a number of the first video images is less than a number of video images in the video to be processed;
determining a first target region of the at least one first video image by performing region recognition on the at least one first video image; and
determining, based on the first target region of the at least one first video image, a second target region of at least one second video image in the video to be processed other than the first video images, wherein the second video image is associated with the first video image.

2. The method according to claim 1, wherein said acquiring the at least one first video image in the video to be processed comprises:
acquiring the at least one first video image by selecting, starting from a first frame in the video to be processed, one first video image every N frames, wherein N is an integer greater than or equal to 1; or
freely selecting at least one video image from the video images in the video to be processed as the at least one first video image.

3. The method according to claim 1, wherein said determining, based on the first target region of the at least one first video image, the second target region of the at least one second video image in the video to be processed other than the first video images comprises:
determining, based on time sequences of the video images in the video to be processed, the at least one second video image associated with the at least one first video image, wherein a time sequence of the second video image is between one first video image and a next first video image; and
acquiring the second target region of the at least one second video image by performing image tracking on the first target region of the at least one first video image.

4. The method according to claim 1, wherein said determining, based on the first target region of the at least one first video image, the second target region of the at least one second video image in the video to be processed other than the first video images comprises:
acquiring motion information of the at least one second video image, the motion information of the second video image comprising a displacement amount and a displacement direction of each pixel point in a plurality of video image blocks of the second video image relative to a corresponding pixel point in a previous video image; and
determining, based on the first target region of the at least one first video image and the motion information of the at least one second video image, the second target region of the at least one second video image.

5. The method according to claim 4, wherein said determining, based on the first target region of the at least one first video image and the motion information of the at least one second video image, the second target region of the at least one second video image comprises:
determining, based on the motion information of the second video image, mapping regions of the plurality of video image blocks in the previous video image of the second video image; and
acquiring target video image blocks, and determining a region formed by the target video image blocks as the second target region of the second video image, wherein the mapping region of the target video image block is in the first target region or the second target region of the previous video image.

6. The method according to claim 5, wherein said determining, based on the motion information of the second video image, the mapping regions of the plurality of video image blocks in the previous video image of the second video image comprises:
acquiring, from the motion information of the second video image, the displacement direction and the displacement amount of each pixel point in each of the video image blocks; and
mapping, based on the displacement direction and the displacement amount, each pixel point in each of the video image blocks from the second video image to the previous video image, and determining a region formed by mapped pixel points as a mapping region.

7. The method according to claim 4, further comprising:
dividing the second video image into the plurality of video image blocks;
for any video image block, in the case that the motion information of the second video image does not comprise motion information of the video image block, determining whether a mapping region of an adjacent image block of the video image block is in the first target region or the second target region of the previous video image; and
in the case that the mapping region of the adjacent image block is in the first target region or the second target region of the previous video image, determining the video image block as a target video image block.

8. The method according to claim 4, wherein said acquiring the motion information of the at least one second video image comprises:
acquiring the motion information of the at least one second video image from first encoded data of the video to be processed; or
acquiring re-encoded data of the video to be processed by re-encoding the video to be processed, and acquiring the motion information of the at least one second video image from the re-encoded data.

9. An electronic device comprising:
a processor; and
a memory configured to store one or more instructions executable by the processor;
wherein the processor, when loading and executing the one or more instructions, is caused to:
acquire at least one first video image in a video to be processed, wherein a number of the first video images is less than a number of video images in the video to be processed;
determine a first target region of the at least one first video image by performing region recognition on the at least one first video image; and
determine, based on the first target region of the at least one first video image, a second target region of at least one second video image in the video to be processed other than the first video images, wherein the second video image is associated with the first video image.

10. The electronic device according to claim 9, wherein the processor, when loading and executing the one or more instructions, is caused to:
acquire the at least one first video image by selecting, starting from a first frame in the video to be processed, one first video image every N frames, wherein N is an integer greater than or equal to 1; or
freely select at least one video image from the video images in the video to be processed as the at least one first video image.

11. The electronic device according to claim 9, wherein the processor, when loading and executing the one or more instructions, is caused to:
determine, based on time sequences of the video images in the video to be processed, the at least one second video image associated with the at least one first video image, wherein a time sequence of the second video image is between one first video image and a next first video image; and
acquire the second target region of the at least one second video image by performing image tracking on the first target region of the at least one first video image.

12. The electronic device according to claim 9, wherein the processor, when loading and executing the one or more instructions, is caused to:
acquire motion information of the at least one second video image, the motion information of the second video image comprising a displacement amount and a displacement direction of each pixel point in a plurality of video image blocks of the second video image relative to a corresponding pixel point in a previous video image; and
determine, based on the first target region of the at least one first video image and the motion information of the at least one second video image, the second target region of the at least one second video image.

13. The electronic device according to claim 12, wherein the processor, when loading and executing the one or more instructions, is caused to:
determine, based on the motion information of the second video image, mapping regions of the plurality of video image blocks in the previous video image of the second video image; and
acquire target video image blocks, and determine a region formed by the target video image blocks as the second target region of the second video image, wherein the mapping region of the target video image block is in the first target region or the second target region of the previous video image.

14. The electronic device according to claim 13, wherein the processor, when loading and executing the one or more instructions, is caused to:
acquire, from the motion information of the second video image, the displacement direction and the displacement amount of each pixel point in each of the video image blocks; and
map, based on the displacement direction and the displacement amount, each pixel point in each of the video image blocks from the second video image to the previous video image, and determine a region formed by mapped pixel points as a mapping region.

15. The electronic device according to claim 12, wherein the processor, when loading and executing the one or more instructions, is caused to:
divide the second video image into the plurality of video image blocks;
for any video image block in the case that the motion information of the second video image does not comprise motion information of the video image block, determine whether a mapping region of the adjacent image block of the video image block is in the first target region or the second target region of the previous video image; and
in the case that the mapping region of the adjacent image block is in the first target region or the second target region of the previous video image, determine the video image block as a target video image block.

16. The electronic device according to claim 12, wherein the processor, when loading and executing the one or more instructions, is caused to:
acquire the motion information of the at least one second video image from first encoded data of the video to be processed; or
acquire re-encoded data of the video to be processed by re-encoding the video to be processed, and acquire the motion information of the at least one second video image from the re-encoded data.

17. A non-transitory computer-readable storage medium storing one or more instructions therein, wherein the one or more instructions, when executed by a processor of an electronic device, cause the electronic device to:
acquire at least one first video image in a video to be processed, wherein a number of the first video images is less than a number of video images in the video to be processed;
determine a first target region of the at least one first video image by performing region recognition on the at least one first video image; and
determine, based on the first target region of the at least one first video image, a second target region of at least one second video image in the video to be processed other than the first video images, wherein the second video image is associated with the first video image.

18. The computer-readable storage medium according to claim 17, wherein the one or more instructions, when loaded and executed by the processor of the electronic device, cause the electronic device to:
acquire the at least one first video image by selecting, starting from a first frame in the video to be processed, one first video image every N frames, wherein N is an integer greater than or equal to 1; or
freely select at least one video image from the video images in the video to be processed as the at least one first video image.

19. The computer-readable storage medium according to claim 17, wherein the one or more instructions, when loaded and executed by the processor of the electronic device, cause the electronic device to:
determine, based on time sequences of the video images in the video to be processed, the at least one second video image associated with the at least one first video image, wherein a time sequence of the second video image is between one first video image and a next first video image; and
acquire the second target region of the at least one second video image by performing image tracking on the first target region of the at least one first video image.

20. The computer-readable storage medium according to claim 17, wherein the one or more instructions, when loaded and executed by the processor of the electronic device, cause the electronic device to:
acquire motion information of the at least one second video image, the motion information of the second video image comprising a displacement amount and a displacement direction of each pixel point in a plurality of video image blocks of the second video image relative to a corresponding pixel point in a previous video image; and
determine, based on the first target region of the at least one first video image and the motion information of the at least one second video image, the second target region of the at least one second video image.
